(19) United States
(12) Patent Application Publication
(10) Pub. No.: US 2018/0298243 A1
(43) Pub. Date: Oct. 18, 2018

(54) TACKIFIER

(71) Applicant: HARIMA CHEMICALS, INC., Hyogo (JP)

(72) Inventors: Masakazu KONO, Hyogo (JP); Tomoya TANATSUGU, Saitama (JP)

(73) Assignee: HARIMA CHEMICALS, INC., Hyogo (JP)

(21) Appl. No.: 15/766,958

(22) PCT Filed: Oct. 5, 2016
(86) PCT No.: PCT/JP2016/079646

§ 371 Date: Apr. 9, 2018

(30) Foreign Application Priority Data
Oct. 15, 2015 (JP) 2015-203836

(51) Int. Cl. C09J 11/08; C09J 7/38

(52) U.S. Cl. CPC C09J 11/08; C09J 7/385; C09J 2493/00; C09J 2467/006; C09J 2433/00

(57) ABSTRACT

The purpose of the present invention is to provide a tackifier which is superior in adhesiveness under high temperature (heat-resistant holding power) and rough surface adhesiveness to conventional tackifiers produced using rosin acids having a tricyclic skeletal structure. This tackifier is a reaction product of a rosin (A) with an alcohol (B), the rosin (A) containing a rosin acid (a) having a bicyclic skeletal structure. Preferably, the bicyclic skeletal structure is a labdane skeletal structure.

### TECHNICAL FIELD

The present invention relates to a tackifier that is a reaction product of a rosin containing a specific rosin acid with an alcohol.

### BACKGROUND ART

Conventionally, tackifiers are mixed in most of the adhesives in which acrylic copolymers are used as raw materials to adjust the adhesive performance. However, such adhesives chronically suffer from a problem of so-called heat sag in which the adhesive performance is reduced due to softening of the adhesive layer caused by an environmental temperature rise.

Although attempts to improve the heat sag have been made by modifying the acrylic copolymers themselves and enhancing the functionality of tackifiers, it is difficult to be compatible with other adhesive performances, thus failing to achieve preferable results. For example, a tackifier using a rosin acid having a tricyclic skeletal structure has been developed (Patent Literature 1), but it has been still difficult for such a tackifier to satisfy various adhesive properties including the adhesiveness under high temperature (heat-resistant holding power), though it has high dispersibility and high uniformity.

### CITATION LIST

### Patent Literature

### Patent Literature 1

National Publication of International Patent Application No. 2011-522088

### SUMMARY OF INVENTION

### Technical Problem

It is an object of the present invention to provide a tackifier that exerts superior effects in adhesiveness under high temperature (heat-resistant holding power) and rough surface adhesiveness to conventional tackifiers.

### Solution to Problem

As a result of dedicated research, the inventors have achieved the present invention. That is, the present invention is a tackifier that is a reaction product of a rosin (A) with an alcohol (B), wherein the rosin (A) contains a rosin acid (a) having a bicyclic skeletal structure.

### Advantageous Effects of Invention

The tackifier of the present invention exerts superior effects in adhesiveness under high temperature (heat-resistant holding power) and rough surface adhesiveness to tackifiers using a rosin acid having a tricyclic skeletal structure. Further, the tackifier of the present invention has the property of high viscosity in a low temperature region near room temperature.

### BRIEF DESCRIPTION OF DRAWING

FIG. 1 is a graph showing the temperature dependence of the viscosity of tackifiers of Example 1 and Comparative Example 1.

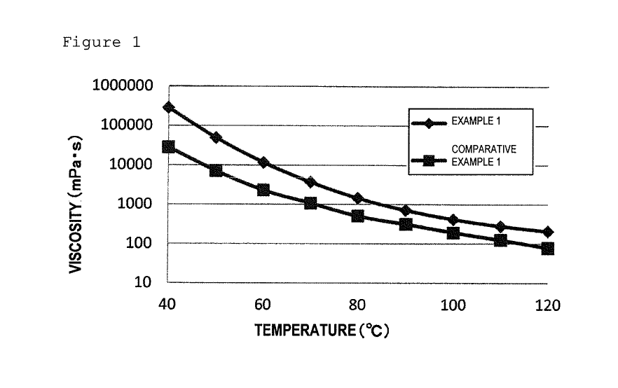

### DESCRIPTION OF EMBODIMENT

The tackifier of the present invention can be used as a component for imparting heat-resistant holding power and rough surface adhesiveness to organic adhesives and aqueous adhesives.

The tackifier of the present invention is a reaction product of a rosin (A) with an alcohol (B), and the rosin (A) contains a rosin acid (a) having a bicyclic skeletal structure.

As described above, the rosin (A) is used for producing the tackifier of the present invention. In this description, the rosin (A) contains not only rosins obtained from natural wood but also modified rosins (rosin derivatives) by heat treatment or the like.

The rosin (A) of the present invention contains the rosin acid (a) having a bicyclic skeletal structure. Rosin acids are organic acids contained in some of various rosins.

The rosin acid (a) having a bicyclic skeletal structure is preferably a rosin acid having a labdane skeletal structure. Rosin acids are generally classified into four basic skeleton groups of abietic acid, pimarane, isopimarane, and labdane.

As the rosin acid having a labdane skeletal structure, communic acid, anticopalic acid, lambertianic acid, merkusic acid, acetylisocupressic acid, acetylimbricataloic, and imbricataloic acid are preferable. Among them, communic acid, anticopalic acid, merkusic acid, and isobricataloic acid are more preferable.

The rosin acid (a) having a bicyclic skeletal structure is contained in the rosin (A) preferably in an amount of 0.1 to 15 parts by mass, more preferably 1 to 15 parts by mass. Such an amount is preferable because, when the amount is 0.1 parts by mass or more, the viscosity of the tackifier to be obtained increases, and when the amount is 15 parts by mass or less, the cost is not excessively high. When the amount is 1 to 15 parts by mass, the balance of cost-effectiveness is good.

The rosin (A) can contain a rosin acid having a tricyclic skeletal structure and additional components, other than the rosin acid (a) having a bicyclic skeletal structure. Examples thereof include conjugate acids such as abietic acid, palustric acid, and neoabietic acid; pimaric acids such as sandaracopimaric acid, pimaric acid, and isopimaric acid; and nonconjugated acids such as dehydroabietic acid. The content of such a rosin acid having a tricyclic skeletal structure is preferably 95 mass % or less, more preferably 90 mass % or less. The lower limit is not particularly specified but is, for example, 85 mass % or more. When the content of the rosin acid having a tricyclic skeletal structure is excessively high, the content of the rosin acid (a) having a bicyclic skeletal structure is relatively reduced, which is not preferable because the expression of the effects is reduced.

The rosin (A) used in the present invention is not specifically limited, as long as it is a rosin containing the rosin acid (a) having a bicyclic skeletal structure. Wood rosin, tall oil rosin, gum rosin, or the like can be used therefor. These rosins may be used while they are unpurified, but are preferably purified in use.

The tackifier of the present invention can be obtained by reacting the rosin (A) containing the rosin acid (a) with the alcohol (B). The rosin acid (a) having a bicyclic skeletal structure contained in the rosin (A) reacts with the alcohol (B) to esterify some or all of the carboxyl groups of the rosin acid (a). The charge ratio of the rosin (A) to the alcohol (B) is preferably about COOH/OH=1/(0.2 to 2.0) in terms of hydroxyl group equivalent ratio of the alcohol with respect to the carboxyl group equivalent amount.

The alcohol (B) to be used is not specifically limited, as long as it can cause esterification reaction with the rosin acid (a) in the rosin (A). The component (B) used for producing polymerized rosin esters is not specifically limited, as long as it is a compound having a hydroxyl group. For example, known components can be used therefor. Specifically, examples thereof include monohydric alcohols such as methanol, ethanol, propanol, isopropanol, butanol, isobutanol, t-butyl alcohol, pentanol, hexanol, cyclohexanol, octanol, 2-ethyl hexanol, decyl alcohol, and lauryl alcohol; dihydric alcohols such as ethylene glycol, diethylene glycol, polyethylene glycol, propylene glycol, polypropylene glycol, neopentyl glycol, and cyclohexanedimethanol; trihydric alcohols such as glycerin, trimethylol ethane, and trimethylolpropane; tetrahydric alcohols such as pentaerythritol and diglycerol; and pentahydric or higher alcohols such as dipentaerythritol. One of these can be used alone, or two or more of them can be mixed for use. Above all, a polyol having a plurality of hydroxyl groups in one molecule is preferable, and a polyol containing 2 to 4 hydroxyl groups in one molecule is further preferable. Examples thereof include diethylene glycol, triethylene glycol, glycerin, pentaerythritol, dipentaerythritol, and trimethylolpropane, preferably diethylene glycol and triethylene glycol. Two or more of these polyols can be used in combination.

A method for reacting the rosin (A) with the alcohol (B) will be described. First, the rosin (A) is dissolved at 150° C. to 350° C. and is allowed to react in the presence of an esterification catalyst. When the temperature is excessively low, the rosin is not sufficiently dissolved. When the temperature is excessively high, the alcohol (B) may possibly be scattered. When a polyol is used as the alcohol, monoesters are first prepared preferably in a range of 150° C. to 250° C., and then diesters are produced by increasing the temperature within a range of 250° C. to 300° C. The reaction time is 0.5 to 10 hours, but when the reaction proceeds in two stages, the reaction time in each stage is 3 to 5 hours.

The number average molecular weight of the esterified rosin obtained by the reaction is 400 to 800, preferably 500 to 700.

The viscosity of the tackifier of the present invention is preferably 100,000 to 1,000,000 mPa·s at 40° C., more preferably 200,000 mPa·s to 800,000 mPa·s at 40° C. This viscosity level is higher at the same temperature than that of rosin acids having a tricyclic skeletal structure that have been conventionally used. It is considered that this viscosity level allows the expression of the superior effects in adhesiveness under high temperature (heat-resistant holding power) and rough surface adhesiveness.

Organic adhesives can be produced by mixing the tackifier of the present invention with a base polymer, a solvent, and a crosslinking agent at an appropriate ratio. Further, aqueous adhesives can be also produced by mixing the tackifier of the present invention with a base polymer, water, and a thickener at an appropriate ratio.

In the case of producing organic adhesives, acrylic resins, for example, are used as the base polymer. The acrylic resins are not particularly limited, and various known homopolymers or copolymers that have been used as adhesives can be used as they are. As monomers used in acrylic resins, various (meth)acrylic acid esters (where the (meth)acrylic acid esters refer to acrylic acid esters and/or methacrylic acid esters, and the same applies to the (meth) below) can be used. Specific examples of the (meth)acrylic acid esters include methyl (meth)acrylate, ethyl (meth)acrylate, buthyl (meth)acrylate, and 2-ethylhexyl (meth)acrylate. These can be used alone or in combination. Further, a small amount of (meth)acrylic acid can be used instead of part of the (meth)acrylic acid esters for imparting polarity to acrylic resins to be obtained. Further, it is also possible to use glycidyl (meth)acrylate, 2-hydroxyethyl (meth)acrylate, N-methylol (meth)acrylamide, or the like as crosslinkable monomers in combination. Further, it is also possible to use other copolymerizable monomers such as vinyl acetate and styrene in combination, if desired, without impairing the adhesive properties of (meth)acrylic acid ester polymer.

In this case, polar solvents such as ethyl acetate and toluene are generally used as the solvent.

It is also possible to further improve the cohesion and the heat resistance by adding a crosslinking agent such as a polyisocyanate compound, a polyamine compound, a melamine resin, a urea resin, and an epoxy resin as the crosslinking agent.

In the case of producing aqueous adhesives, examples of the base polymer include acrylic emulsions. Acrylic polymer emulsions generally used for various acrylic adhesives can be used therefor and can be easily produced by known emulsion polymerization methods such as a polymerization method of loading (meth)acrylic acid esters batchwise, a monomer sequential addition polymerization method, an emulsified monomer sequential addition polymerization method, and a seed polymerization method.

Examples of the (meth)acrylic acid esters used for preparing the acrylic emulsions include methyl (meth)acrylate, ethyl (meth)acrylate, buthyl (meth) acrylate, 2-ethylhexyl (meth) acrylate, glycidyl (meth)acrylate, and 2-hydroxyethyl (meth)acrylate. These are used alone, or two or more of these are mixed for use. Further, a small amount of (meth)acrylic acids may be used instead of the (meth)acrylic acid esters for imparting storage stability to the emulsions to be obtained. Further, copolymerizable monomers such as vinyl acetate and styrene can be used in combination, if desired, without impairing adhesive properties of the (meth)acrylic acid ester polymer. The glass transition temperature of the polymer containing these (meth)acrylic acid esters as main components is generally about −70 to 0° C., preferably −60 to −10° C. When the glass transition temperature is over 0° C., the tackiness significantly decreases, which is not preferable. As an emulsifier used for the acrylic emulsions, anionic emulsifiers, partially saponified polyvinyl alcohols, or the like can be used, and the amount thereof used is about 0.1 to 5 parts by mass, preferably 0.5 to 3 parts by mass, with respect to 100 parts by mass of the polymer.

In the case of producing aqueous adhesives, the rosin (A) also may be emulsified in some cases. Examples of the emulsification method of the rosin (A) include inversion emulsification and mechanical emulsification using a high-pressure homogenizer.

Examples of the thickener include PRIMAL ASE-60 (manufactured by Rohm and Haas Japan) that is an acrylic thickener, and other urethane thickeners can be also used therefor.

The aforementioned adhesives can be applied to a substrate such as thin paper or sheets of other materials, to form adhesive tapes.

### EXAMPLES

Next, the present invention will be described based on Examples and Comparative Examples, but the present invention is not limited to the following examples. The “part(s)” and “%” are based on mass, unless otherwise specified. Further, the numerical values of Examples shown below can substitute for the numerical values described in the embodiment (that is, the upper limit value or the lower limit value).

The methods for measuring the physical properties used in Examples and Comparative Examples are shown below.

### <Measurement of Number Average Molecular Weight (Mn) by Gel Permeation Chromatography>

The sample was dissolved in tetrahydrofuran to a sample concentration of 5.0 g/L, and the resultant solution was measured using a gel permeation chromatograph (GPC) equipped with a differential refractive index detector (RID), to obtain the molecular weight distribution of the sample. Thereafter, the number average molecular weight (Mn) of the sample was calculated from the obtained chromatogram (chart) using standard polystyrene as a calibration curve. The measuring device and the measurement conditions are shown below.

Data processor: product number GPC-101 (manufactured by Showa Denko K.K.)
Differential refractive index detector: RI detector incorporated in product number GPC-101
Columns: two sets of product number KF-803, KF-802, and KF-801 (manufactured by Showa Denko K.K.)
Mobile phase: Tetrahydrofuran
Column flow rate: 1.0 mL/min
Sample concentration: 5.0 g/L
Injection volume: 100 μL
Measurement temperature: 40° C.
Molecular weight marker: Standard polystyrene (standard substance SHODEX STANDARD, manufactured by Showa Denko K.K.)

### <Measurement of Weight Average Molecular Weight (Mw) by Gel Permeation Chromatography>

The sample was dissolved in tetrahydrofuran to a sample concentration of 1.0 g/L, and the resultant solution was measured using a gel permeation chromatograph (GPC) equipped with a differential refractive index detector (RID), to obtain the molecular weight distribution of the sample. Thereafter, the weight average molecular weight (Mw) of the sample was calculated from the obtained chromatogram (chart) using standard polystyrene as a calibration curve. The measuring device and the measurement conditions are shown below.

Data processor: product number HLC-8220GPC (manufactured by Tosoh Corporation)
Differential refractive index detector: RI detector incorporated in product number HLC-8220GPC
Columns: two sets of product number TSKgel SuperHZM-H (manufactured by Tosoh Corporation)
Mobile phase: Tetrahydrofuran
Column flow rate: 0.35 mL/min
Sample concentration: 1.0 g/L
Injection volume: 10 μL
Measurement temperature: 40° C.
Molecular weight marker: standard polystyrene (standard substance manufactured by POLYMER LABORATORIES LTD.) (using POLYSTYRENE-MEDIUM MOLECULAR WEIGHT CALIBRATION KIT)

### <Viscosity Measurement>

Using a rotational viscometer, manufactured by Toyo Seiki Seisaku-sho, Ltd., the sample was collected in a special container for small applicators (small sample adapter), and the viscosity was measured at a temperature of 40° C. to 120° C. under the following conditions.

Sample volume: 10 ml
Measurement viscometer: TVB-22L (spindle type, manufactured by Toyo Seiki Seisaku-sho, Ltd.)
Rotor: TM1 (rotor for small samples, manufactured by Toyo Seiki Seisaku-sho, Ltd.)
Temperature adjuster: VTB-250 (block thermostatic bath, manufactured by Toyo Seiki Seisaku-sho, Ltd.)
Temperature conditions: 40 degrees to 120 degrees; the viscosity was measured every 10 degrees of temperature rise.

### Example 1

A Brazilian rosin containing a rosin acid having a bicyclic skeletal structure was put into a flask provided with a stirrer, a divided water receiver, a cooling tube, and a thermometer and was dissolved under a nitrogen atmosphere and heating, and stirring was started. After the temperature inside the flask reached 180° C., 1.31 parts by mass of CG-100 (esterification catalyst), Tackrol AP (color brightener), 65.3 parts by mass of triethylene glycol, 65.3 parts by mass of diethylene glycol, and two drops of a defoamer were put into the flask. After the raw materials were put therein, the temperature was raised to 220° C. Monoesters were prepared by maintaining the reaction temperature at 220° C. for three hours in order to suppress the scattering of alcohol. Next, the reaction temperature was raised from 220° C. to 270° C. over three and a half hours. Esterification reaction was allowed to proceed by maintaining the temperature at 270° C. After measuring the acid value of the obtained reaction product and confirming that the acid value was 20 or less, cooling was started, and ADK STAB PEP-8 (antioxidant) was added at 220° C. The internal temperature was adjusted to 140° C. or less, and the mixture was filtered with a wire mesh having a 100-mesh size, so that a tackifier (b) having a number average molecular weight of 606 (using a GPC, manufactured by Showa Denko K.K.) was obtained. The Brazilian rosin used in Example 1 contained 23 mass % of abietic acid, 28 mass % of palustric acid, 19 mass % of neoabietic acid, 2 mass % of sandaracopimaric acid, 5 mass % of pimaric acid, 13 mass % of isopimaric acid, 5 mass % of dehydroabietic acid, and 5 mass % of communic acid having a labdane skeleton.

### Comparative Example 1

A tackifier (c) having a number average molecular weight of 562 (using a GPC, manufactured by Showa Denko K.K.) was obtained under the same conditions as in Example 1 except that a conventionally used Chinese rosin free from a rosin acid having a bicyclic skeletal structure was used instead of the Brazilian rosin used in Example 1. The Chinese rosin used in Comparative Example 1 contained 42 mass % of abietic acid, 20 mass % of palustric acid, 17 mass % of neoabietic acid, 3 mass % of sandaracopimaric acid, 7 mass % of pimaric acid, 5 mass % of isopimaric acid, and 6 mass % of dehydroabietic acid. That is, a rosin acid having a bicyclic skeletal structure was not contained therein.

### Preparation of Adhesive Composition and Production of Adhesive Sheet

600 parts of toluene as a solvent was put into a flask provided with a stirrer, a condenser, a thermometer, an inert gas inlet tube, and a dropping funnel, and an inert gas (nitrogen gas) was introduced therein. Then, the temperature was raised to 85° C. Thereafter, a mixture composed of, as copolymerizable monomers, 416 parts of n-butyl acrylate, 416 parts of 2-ethylhexyl acrylate, 15.3 parts of acrylic acid, 0.2 parts of 1.6-hexanediol diacrylate, 2.5 parts of 2-hydroxyethyl acrylate, 32.0 parts of toluene, and 1 part of t-butyl peroxy-2-ethylhexanate (product name PERBUTYL 0, manufactured by NOF CORPORATION) as a polymerization initiator was added dropwise thereto over 2 hours under stirring through the funnel. Thereafter, the temperature was raised to 95° C., and 2.53 parts of t-butyl peroxy-2-ethylhexanate as a polymerization initiator was added thereto 30 minutes after the temperature reached 95° C. Further, 2.53 parts thereof and 8.00 parts of toluene were added thereto one hour later, and the reaction was allowed to proceed for one hour. After the completion of the reaction, 216 parts of toluene was added thereto, followed by stirring for one hour, to obtain an acrylic polymer (d) having a non-volatile content of 50 mass % and a weight average molecular weight of 400,000 (using a GPC, manufactured by Tosoh Corporation).

### Preparation Example 1

An adhesive composition (e) (prototype using the tackifier (b)) was prepared by mixing 100 parts of the obtained acrylic polymer (d), 5 parts of the tackifier (b) obtained in Example 1, and 2 parts of Coronate L-45E (a 45% ethyl acetate solution of tolylene diisocyanate, manufactured by Nippon Polyurethane Industry Co., Ltd.) as a curing agent, followed by stirring. Table 1 shows various properties of the adhesive composition.

### Preparation Example 2

An adhesive composition (f) (prototype using the tackifier (c)) was prepared in the same manner as in Preparation Example 1 except that the tackifier (c) was used as a tackifier component. Table 1 shows various properties of the adhesive composition.

TABLE 1

Adhesive constant

| | Solid content | Viscosity |
|---|---|---|
| Samples | (%) | (mPa · s) |
| Base acrylic Brazilian gum rosin | 45.1 | 5340 |
| Liquid rosin prototype | | |
| (Example 1) | | |
| Base acrylic Chinese gum rosin | 44.5 | 5250 |
| Liquid rosin prototype | | |
| (Comparative Example 1) | | |

The adhesive compositions obtained in Preparation Example 1 and Preparation Example 2 were each applied to a 25-μm polyethylene terephthalate film: PET film (product name Lumirror T-60, manufactured by Toray Industries, Inc.) as a substrate so as to have a film thickness after drying of 25 μm.

Thereafter, they were dried in the atmosphere at 100° C. for 5 minutes, and then were covered with a 75-μm PET film (product name SPPET7501BU, manufactured by PANAC CO., LTD.) subjected to surface release treatment, followed by curing at 40° C. for three days, to obtain an adhesive sheet for evaluating adhesive properties.

Further, an adhesive sheet for evaluating compatibility was produced in the same manner as above except that a 50-μm PET film (product name SPPET5003BU, manufactured by PANAC CO., LTD.) subjected to release treatment was used as a substrate instead of the 25-μm PET film.

### Evaluation

The adhesive properties were evaluated by the following methods using the adhesive sheet for evaluating adhesive properties. Further, the compatibility with acrylic resins was evaluated using the adhesive sheet for evaluating compatibility.

### (1) Adhesive Properties of Adhesive Sheet

The 75-μm PET film subjected to release treatment on the adhesive sheet for evaluating adhesive properties was removed, and the measurement was performed according to JIS Z 0237 (2009). However, in order to clearly check the difference in heat resistance, only the holding power was measured at 60° C. Table 2 shows the obtained results.

TABLE 2

| | Adhesive force | | | | | | | | | Holding power (mm or sec) | | | | | |
|---|---|---|---|---|---|---|---|---|---|---|---|---|---|---|---|
| | Substrate SUS | | | | Substrate PE | | | | Ball | Displacement distance at | | | | | |
| | (N/25 mm) | | | | (N/25 mm) | | | | tack | 60° C. after one hour | | | | | |
| Samples | 1 | 2 | 3 | Average | 1 | 2 | 3 | Average | No | 1 | 2 | 3 | 4 | 5 | Average |
| Base acrylic Brazilian gum rosin | 11.0 | 10.2 | 10.1 | 10.4 | 6.2 | 6.1 | 5.9 | 6.1 | 16 | 0.00 | 0.00 | 0.00 | 0.00 | 0.00 | 0.00 |
| Liquid rosin prototype (Example 1) | | | | | | | | | | | | | | | |
| Base acrylic Chinese gum rosin | 10.5 | 10.5 | 10.6 | 10.5 | 5.4 | 5.3 | 5.6 | 5.4 | 14 | 0.75 | 0.15 | 0.10 | 0.10 | 0.05 | 0.23 |
| Liquid rosin prototype | | | | | | | | | | | | | | | |
| (Comparative Example 1) | | | | | | | | | | | | | | | |

### (2) Compatibility

The haze and the total light transmittance (%) of the adhesive sheet for evaluating compatibility were measured as indices of the compatibility with an acrylic resin that was the base polymer.

The 75-μm PET film subjected to release treatment on the adhesive sheet for evaluating compatibility was removed and then was attached to a glass sheet, and the 50-μm PET film subjected to release treatment was removed, to measure the haze and the total light transmittance (%) using a haze meter. For the measurement, a haze meter NDH2000, manufactured by NIPPON DENSHOKU INDUSTRIES CO., LTD. was used. Table 3 shows the obtained results.

TABLE 3

| | Total light | | | | Haze | | | |
|---|---|---|---|---|---|---|---|---|
| | transmittance % | | | | (transmittance) % | | | |
| Samples | 1 | 2 | 3 | Average | 1 | 2 | 3 | Average |
| Base acrylic Brazilian gum rosin | 91.4 | 91.9 | 91.9 | 91.8 | ◯ | ◯ | ◯ | ◯ |
| Liquid rosin prototype (Example 1) | | | | | | | | |
| sBase acrylic Chinese gum rosin | 91.9 | 91.9 | 91.9 | 91.9 | ◯ | ◯ | ◯ | ◯ |
| Liquid rosin prototype | | | | | | | | |
| (Comparative Example 1) | | | | | | | | |

In Table 3, samples having a haze of 2.5% or less were expressed as ◯ (good) in the measurement. All the samples had a haze of 2.5% or less, which is a numerical value of practicable level.

1. A tackifier that is a reaction product of a rosin (A) with an alcohol (B), wherein
the rosin (A) contains a rosin acid (a) having a bicyclic skeletal structure.

2. The tackifier according to claim 1, wherein
the bicyclic skeletal structure is a labdane skeletal structure.

3. The tackifier according to claim 1, wherein
the rosin acid (a) having a bicyclic skeletal structure is contained in an amount of 0.1 to 15 parts by mass with respect to 100 parts by mass of the rosin (A).

4. The tackifier according to claim 1, wherein
the rosin acid (a) having a bicyclic skeleton is at least one selected from the group consisting of anticopalic acid, merkusic acid, imbricataloic acid, and communic acid.

5. The tackifier according to claim 1, wherein
the alcohol (B) is a dihydric to tetrahydric alcohol.

6. The tackifier according to claim 2, wherein
the rosin acid (a) having a bicyclic skeletal structure is contained in an amount of 0.1 to 15 parts by mass with respect to 100 parts by mass of the rosin (A).

7. The tackifier according to claim 2, wherein
the rosin acid (a) having a bicyclic skeleton is at least one selected from the group consisting of anticopalic acid, merkusic acid, imbricataloic acid, and communic acid.

8. The tackifier according to claim 3, wherein
the rosin acid (a) having a bicyclic skeleton is at least one selected from the group consisting of anticopalic acid, merkusic acid, imbricataloic acid, and communic acid.

9. The tackifier according to claim 6, wherein
the rosin acid (a) having a bicyclic skeleton is at least one selected from the group consisting of anticopalic acid, merkusic acid, imbricataloic acid, and communic acid.

10. The tackifier according to claim 2, wherein
the alcohol (B) is a dihydric to tetrahydric alcohol.

11. The tackifier according to claim 3, wherein
the alcohol (B) is a dihydric to tetrahydric alcohol.

12. The tackifier according to claim 4, wherein
the alcohol (B) is a dihydric to tetrahydric alcohol.

13. The tackifier according to claim 6, wherein
the alcohol (B) is a dihydric to tetrahydric alcohol.

14. The tackifier according to claim 7, wherein
the alcohol (B) is a dihydric to tetrahydric alcohol.

15. The tackifier according to claim 8, wherein
the alcohol (B) is a dihydric to tetrahydric alcohol.

16. The tackifier according to claim 9, wherein
the alcohol (B) is a dihydric to tetrahydric alcohol.
